(19) United States
(12) Patent Application Publication
(10) Pub. No.: US 2010/0106277 A1
(43) Pub. Date: Apr. 29, 2010

(54) PACKAGE DESIGN METHOD USING STRATODESIGN INTEGRATED IN THE METHOD FOR DESIGNING THE PRODUCT TO BE PACKAGED

(75) Inventors: Claude Barlier, Coinches (FR); Rizad Debboub, Wisenbach (FR)

Correspondence Address: EGBERT LAW OFFICES, 412 MAIN STREET, 7TH FLOOR, HOUSTON, TX, 77002, US

(73) Assignee: CIRTES, SRC, SAINT DIE DES VOSGES (FR)

(21) Appl. No.: 12/530,220

(22) PCT Filed: Mar. 19, 2008
(86) PCT No.: PCT/FR08/50468

§ 371 Date: Sep. 7, 2009

(30) Foreign Application Priority Data
Mar. 23, 2007 (FR) 07/02106

(51) Int. Cl. G06F 17/50

(52) U.S. Cl. 700/98

(57) ABSTRACT

The invention relates to a method for designing and producing a package intended for the protection and/or transportation of a product. All of the digital design steps for the package are integrated in the method for digitizing the product, which includes a step of laminating a virtual key form of the product used to define geometrical data of each layer of the package to be cut. Then, the cutting is carried out followed by the stacking of the layers of the package defined by the design steps for said package to form a real package. The invention also relates to the package obtained by the method.

### RELATED U.S. APPLICATIONS

Not Applicable.

### STATEMENT REGARDING FEDERALLY SPONSORED RESEARCH OR DEVELOPMENT

Not Applicable.

### REFERENCE TO MICROFICHE APPENDIX

Not Applicable.

### BACKGROUND OF THE INVENTION

1. Field of the Invention

The present invention relates to a novel package design method and a package obtained by the method.

2. Description of Related Art Including Information Disclosed Under 37 CFR 1.97 and 37 CFR 1.98

One main objective of the invention is to propose a method for designing a package by total integration of the method in the product's digital design system in order to effectively meet the cost and lead time constraints by eliminating the production of costly toolage.

The package according to the invention is designed at the same time as the product (from the initial CAD file) or after digitization of the physically produced product (retro-design).

This method uses the digital definition of the part (obtained by digitization or by direct CAD) to digitally produce, using automatic software, the laminated design of the package. This package is then produced by stratoconception from sheets of selected material and using an appropriate cutting means.

This method applies in particular to packages for products with high added value, such as in the automobile, aeronautical, medical, art, glassware and other such sectors, for example.

The invention offers the benefit of proposing a package from the digital surface of a given product and not from the projection of its 2D contour or the 2D contour of a tool as is the case in document D1-U.S. Pat. No. 7,031,788. The key form obtained with the invention gives a perfectly enveloping package which therefore offers better safety for transportation. Document D1 also proposes a 2D machining from a block and not, as in the invention, a 3D machining of complex shapes that can be hollow in order to envelop, after their stacking, the 3D shape of the products.

The prior art also includes a document D2-FR 2 717 734 which relates to a machining technique that works by eliminating an external volume of an object. D2 provides for the application of this technique to the production of packages, but there is nothing in this document to enable those skilled in the art to consider the direct and automatic production of the package simply from the digital definition of the product to be packaged as is the case in the present invention.

### BRIEF SUMMARY OF THE INVENTION

The aim of the invention is achieved through a method for designing and producing a package intended for the protection and/or transportation of a product. All of the digital design steps for the package are integrated in the method for digitizing the product, which includes a step of laminating a virtual key form of the product from the digital definition of said product, used to define geometrical data of each layer of the package to be cut. Then, the cutting is carried out followed by the stacking of the layers of the package defined by the design steps for said package to form a real package.

The digital lamination method used in the invention is known by the name of “stratoconception”.

The invention also relates to a package for the protection and/or the transportation of a product, which is obtained by stacking layers of material, the shapes and the dimensions of which have been defined according to a method hereinabove.

### BRIEF DESCRIPTION OF THE SEVERAL VIEWS OF THE DRAWINGS

The invention will be better understood from the following description, given with reference to the following appended figures.

FIG. 1 is a perspective view of a virtual digital model of a first exemplary product to be packaged.

FIG. 2 is an exploded perspective view of the automatic generation of a key form for the product of FIG. 1.

FIG. 3 is a top plan view of the parts forming the package of the product of FIG. 1.

FIG. 4 is a perspective view of the product being packaged in its package.

FIGS. 5 and 6 are perspective views of the package, seen from above and below, respectively, for the product of FIG. 1.

FIG. 7 is a perspective view of a second exemplary product to be packaged.

FIG. 8 is another perspective view of generation of a key form for the product of FIG. 7.

FIG. 9 is another perspective view of a digital virtual lamination of the key form of FIG. 8 and definition of the layers.

FIG. 10 is a perspective view of stacking of the cut layers of cardboard on the model of the layers defined previously.

FIG. 11 is a perspective view of a presentation of an appropriate packaging volume.

FIG. 12 is still another perspective view of a package for the product in the key form and in the appropriate packaging of FIG. 11.

FIG. 13 is a perspective view of a conventional package.

### DETAILED DESCRIPTION OF THE INVENTION

In the method of designing a prototype (1), or a virtual model of the product to be packaged, provision is made to integrate in said method one or more automatic design steps for a virtual key form (2) defined digitally, and to virtually cut said key form into layers (3) according to a computer lamination method. The inventive computer method produces all the geometrical data of each layer of material in a sheet to be cut in conjunction with the virtual layer used by it as a model: thickness, contour, placement of holes or other cuts, etc., and, if necessary, placements (4) for accessories and/or preservation products, and/or detection elements, and/or identification to be packaged with the product.

The material selected for the sheet is, for example, cardboard or other recyclable material, for example natural-fiber-based material. It is of course possible to use a non-recyclable material in a sheet form, such as sheet polystyrene.

It is then possible, in parallel and on instructions from the design method, on the one hand to manufacture the product and on the other hand to cut out the layers of cardboard (5) that have just been defined.

The final package (6) is reconstituted by stacking the layers (5ᵢ) generated automatically by the method, and the product can be packaged in the final package (6), which in turn can be placed inside a packaging (7) which has also been determined during the design of the product and of the key form, or identified optimally from a number of existing models.

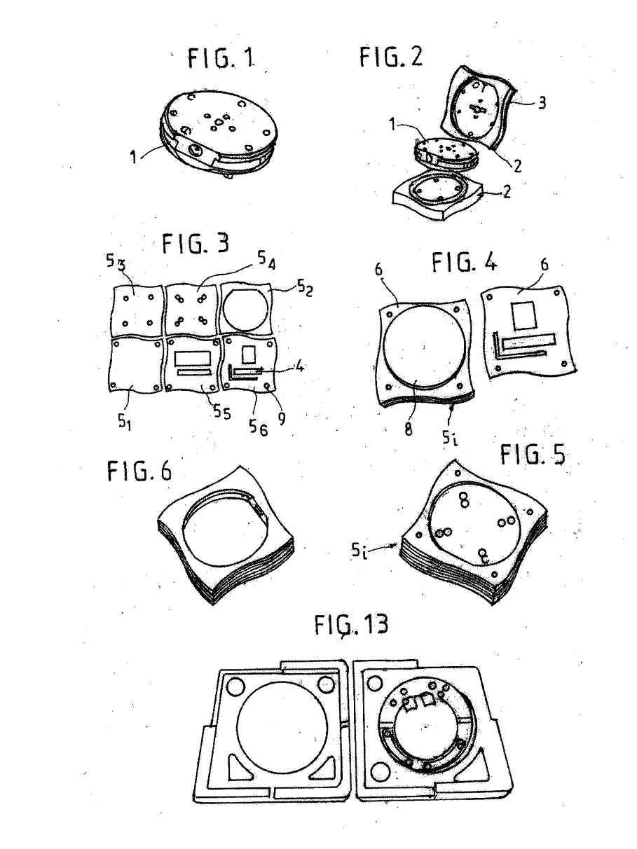

FIGS. 1 to 6 represent, as a first example, the essential steps of the inventive method applied to the package for a typical product, for example a mechanical casing (8).

FIG. 3 represents six different shapes of cut cardboard layers which, after mutual stacking and snap fitting, for example by stamping (9), will form the final package (6). The layers can also be positioned relative to each other by holes (9) into which positioning and fixing inserts can be inserted. In this case, the layers can be said to be self-supporting. The layers can also be held by the outer packaging, which is then used to position and to hold the stack of layers of material.

Certain layers (5ᵢ) may be solid, another (5₂) may include a main cut intended to accommodate the casing (8), others (5₃, 5₄) may include drill holes for the positioning of spindles, others (5₅, 5₆) placements (4) for the housing of accessories for example, and finally others can be made up of separate areas.

At the same time as designing the layers, the method automatically supplies a numbering of the layers and an assembly drawing, on paper or on screen, indicating the relative order according to which the layers must be stacked and the product positioned.

As the figures show, the outer contours of the layers of material are not necessarily straight or polygonal.

This package advantageously replaces a packaging of the prior art (see FIG. 13) produced from injection-molded polystyrene, which requires costly toolage and makes the package difficult to recycle.

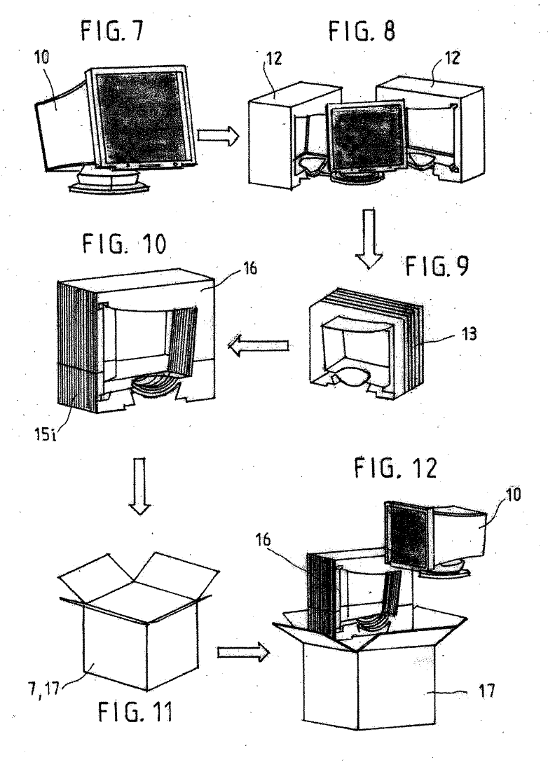

FIGS. 7 to 11 represent a second example of the successive steps of the inventive method applied to the package/packaging of another typical product, for example a computer screen.

The part to be packaged (10) and its virtual key form (12) (FIG. 8) is defined virtually (FIG. 7), and then a virtual lamination (13), displayed on a computer screen (FIG. 9), is applied to it. The layers of cardboard (15ᵢ) are then cut and stacked to form a package (16) including a cavity in which the product is housed and immobilized. Since the outer shape of the layers is rectangular, the final package is parallelepipedal and is housed in a packaging (17), the design of which was provided for at the same time as that of the key form and of the lamination or the choice of which can be made from existing stored standard models.

The appropriate lamination method for integrating the package design and cutting steps and, possibly, the packaging design and cutting steps, is the so-called STRATOCONCEPTION™ method of the Applicant and is the subject of a number of patents, notably including patent EP0585502 and its subsequent refinements, the contents of which are incorporated herein.

The following comparative table reveals the main benefits of the method and of the product according to the invention.

| | Conventional package | |
|---|---|---|
| Criteria | (example in FIG. 13) | Inventive package |
| Production capacity | Product packaged in | Product custom- |
| | series production | packaged to order |
| Recycling | Difficult because of the | 100% recycled |
| | polystyrene | |
| | 40% recycled | |
| Client type | Retail industry | Manufacturers of parts |
| | | with high added value |
| Reactivity | Low (high costs and | High (no toolage |
| | lead times) | design) |
| Flexibility | Lacks flexibility | Very great flexibility |
| | because of the | No toolage design |
| | production time, costs | Flexibility of the digital |
| | and studies (toolage, | line |
| | design office, etc.) | |

The benefits also include:

possibility of taking into account existing packaging boxes that will be stored,
possibility of storing an existing product (not designed by CAD or for which there is no CAD),
possibility of identifying the layers to facilitate assembly,
possibility of producing 2D or 3D layers by rapid micromilling, 5-axes laser, water jet, hot wire cutting, for example. The 3D layers offer the benefit of being very close to the exact shape of the product to be packaged,
optimization of the material used from the fact that the package encompasses the product as precisely as possible, and
direct and automatic production of the package for the product simply from the digital definition of said product.

1. A method for designing and producing a package intended for the protection and/or transportation of a product, the method comprising the steps of:
integrating all digital design steps for digitizing the product to be in the package; and,
laminating a virtual key form of the product from the digital definition of said product, used to define geometrical data of each layer of the package to be cut.

2. The method as claimed in claim 1, further comprising:
cutting the package; and
stacking of the layers of the package defined by the design steps for said package to form a real package.

3. The method as claimed in claim 1, wherein digitizing the product is comprised of a digital design of said product, making it possible to obtain a CAD file from which the package is automatically designed.

4. The method as claimed in claim 1, wherein digitizing the product is a retro-design of an existing product, making it possible to obtain therefrom a digital file from which the package is automatically designed.

5. The method as claimed in claim 1, wherein numbers the layers of the package and automatically supplies the relative order of the stacking of the layers in relation to the placement of the part.

6. A package for the protection and/or transportation of a product, the package being obtained by stacking layers of material, the shapes and dimensions of which have been defined according to a method as claimed in claim 1.

7. The package as claimed in claim 6, wherein the layers of material are comprised of layers of recyclable material.

8. The package as claimed in claim 6, wherein the layers are comprised of positioning means with the adjacent layers.

9. The package as claimed in claim 6, wherein the layers are comprised of a plurality of recesses to incorporate accessories.

10. The package as claimed in claim 6, wherein the layers are held by the outer packaging.
